(19) United States
(12) Patent Application Publication
(10) Pub. No.: US 2011/0017750 A1
(43) Pub. Date: Jan. 27, 2011

(54) Pots and Pans, Frying Pans and Stock Pots with Dividers and Separations

(76) Inventor: Eolita Ines Fortkamp, Maringa (BR)

Correspondence Address: PRYOR CASHMAN, LLP, 7 Times Square, NEW YORK, NY, 10036-6569, US

(21) Appl. No.: 12/624,209

(22) Filed: Nov. 23, 2009

(30) Foreign Application Priority Data
Jul. 27, 2009 (BR) 0000220904733880
Aug. 26, 2009 (BR) 0000210905393350

(51) Int. Cl. A47J 27/00; A47J 36/16

(52) U.S. Cl. 220/573.1; 220/694

(57) ABSTRACT

A set of pots and pans which are provided with separating or dividing walls to allow for preparation at the same cooking time of individually spiced or prepared meals or, alternatively, to allow for the simultaneous preparation of multiple dishes for a meal, such that, in either case, the meal being prepared in one section of the divided pot or pan does not come into contact with the meal or food being prepared in another section of the pot or pan.

### RELATED APPLICATIONS

This application claims priority under 35 USC Section 119 on Applicant's earlier filed Brazil Design and Utility Patent Applications, filed Aug. 26, 2009 and Jul. 27, 2009 and assigned Serial No. 0000210905393350 and 0000220904733880, respectively.

### BACKGROUND OF THE INVENTION

The general subject matter for this invention relates to the technical field of cooking utensils and, more specifically, relates to providing pots and pans with dividers or separations. The invention was specifically developed for the preparation of individually separate, two, three, four or more types of food with a single pot or pan for cooking food for a hot meal over a stove. In this manner, it is possible to prepare a variety of foods and have their tastes, even if the same basic food is served to each member of a family or group sitting at a meal, personalized, with spices and quantities individualized. This becomes an ideal solution to solution, rather than sequentially making individual meals for a group or a family the cook will be able to make everyone's meal at the same time, by using the single pot or pan on a stove top or cooking surface and, yet, each meal is cooked to the individual's taste in terms of types of spices; flavors, and herbs; their quantities and mixtures. This is because the present invention provides a single pot or pan for cooking on a stove top or cook stove surface (or in an oven) with one or more integrated or placeable and then removable divider or separator walls on the inside of the pot/pan. The bottom surface is conventional so that the pot or pan sits on the heating element and all of the individual compartments, separated by the divider walls, will heat up their contents at the same time, and, yet, each food held within the confines of the common outer wall and the divider walls will be able to be individualized in spices, mixtures of spices, quantities, etc. In this manner, many meals can be individualized for taste and spices and, yet, all meals are simultaneously cooked. In this manner, a single meal will provide all of the eaters with their meal at the same time and, yet, each meal is uniquely made according to individual taste of the eater.

In this manner it becomes possible to prepare a variety of foods and personalization of the preparation of the meals to the individual likes and dislikes of spices and seasonings. The economy of doing so with a single pot/pan with a single stove-top or heat providing/engaging surface and with individual compartments to allow for the individual tastes rather than serially making individual meals should be readily apparent. The convenience, too, of making all meals at the same time is helpful for the cook and allows the group or family to enjoy their meals at the same time as they are prepared at the same time. The present invention allows for reduction in gas or electric stove use, in ovens, or on stove tops, a decrease in the time for washing the pots and pans (if several are used to accommodate the individual meals) and optimizes the use of the stove top.

Most foods made for meals, whether breakfast, lunch or dinner, are prepared hot and if care is given to making each person in the group or family happy with their meal, the meal is individually seasoned or provided with spices which suit the taste of the individuals of the group or family. If in the absence of the present invention, individual pots and pans are used, one for each member of the group or family, so that everyone can eat at the same time, highly preferred in a family meal, then the cook often is using multiple pots and pans and multiple burners, sometimes four of six available if there are only four members of the group or family. If multiple pots and pans are so used, there is then an accumulation of dirty pans at the end of the food preparation. In contrast, by use of the present invention, a single pan is provided with a single common heating surface which can be placed over a single heating element and, yet, by providing the insider of the pot and/or pan with dividing walls, multiple meals, each individualized for the taste of a family or group member can result in less pots and pans to clean, less to tend during the meal preparation, and a conservation of heat during cooking.

In many families, there are people with allergies and peculiarities about the food, the spices, in quantity and type, and thus the taste of the food. Some prefer certain types of spices or foods, and others dislike those spices or are allergic to them. Some members of a group need to be sure not to eat certain foods for health reasons. Some need to eat balanced and nutritional meals while others can indulge with less healthy meals. Some watch the quantity of food intake while others are less careful and need to consume more to maintain strength or health, etc.

### BRIEF DESCRIPTION OF THE INVENTION

According to the invention, pots and pans, stove top cooking implements which facilitate cooking by their bottoms being heated, either electrically or by burning gas therebeneath, as, by example, with an electric or gas-powered stove top, are provided in different sizes and shapes, however all are provided with a separator wall or division-providing mechanism for the interior of the pot or pan to allow for individual preparation of food, to suit several (more than one) eater's particular taste.

Usually people that buy pots and pans (collectively called “cooking implements”) in a single set, which range in sizes or diameters to accommodate different quantities of cooking food material. It is usual and expensive and takes up quite a bit of storage room in a kitchen for a buyer to purchase and then use on a stove top multiple quantities of the same size cooking implements. However, it appears to be a real need for a cooking implement, with a single and substantially continuous bottom cooking surface to be provided with one or more internal separators to produce multiple compartments within the cooking implement to allow for a single time of cooking of the meal or entrée preparation to individual tastes, spices, combination of spices and quantities, too. Since a set of normal cooking implements is made of various sizes, the cook will sometimes make the meal in a pot or pan which is not properly sized for the individual entrée to be served. Thus, sauce is made in a pot much larger than necessary; cooking of vegetables, eggs or dairy, among others is made in a pot/pan not ideally suited to the quantity of food being cooked at that time and, yet, it is sized for the number of people, in general to be served. Besides that problem, as mentioned above, there is the issue of waste of electric or gas, lack of space for the preparation of the wider range of food, accumulation of pots; cost to buy more post of the same size, etc.

The present invention contemplates providing a pot or pan, i.e., a cooking implement, with an internal separator or divider wall. This important feature will allow for the simultaneous cooking of the meal with each person of the group or family having his or her main course cooked to their individual taste and, yet, all meals for all members of the group or family will have their meals cooked at the same time, for unified and pleasant eating.

### BRIEF DESCRIPTION OF THE DRAWINGS

FIG. 1.1 is a perspective view of a pan with one dividing wall, a separator, causing the internal surface of the pan to be divided into two cooking compartments;

FIG. 1.2 is a top view of the pan with the single dividing wall, a separator, showing the two cooking compartments.

FIG. 1.3 is a side view of the pan with the dividing wall, a separator, and the two cooking compartments.

FIG. 2.1 is a perspective view of the pot with two dividing walls, separators, causing the internal surface of the pan to be divided into three compartments.

FIG. 2.2 is a top view of the pan with the two dividing walls or separators, again showing the three cooking compartments.

FIG. 2.3 is a side view of the pan shown with two dividing walls or separators, showing three cooking compartments.

FIG. 2.4 represents a front or elevational view of the pan with two dividing walls or separators thus defining three cooking compartments.

FIG. 3.1 shows a perspective view of a frying pan with a single dividing wall, defining a pair of opposed cooking compartments.

FIG. 3.2 shows a top view of the frying pan and a single dividing wall.

FIG. 3.3 shows a side view of a frying pad provided with a single dividing wall, defining a pair of opposed cooking compartments.

FIG. 3.4 shows a front view of a frying pan with the single dividing wall, defining a pair of opposed cooking compartments.

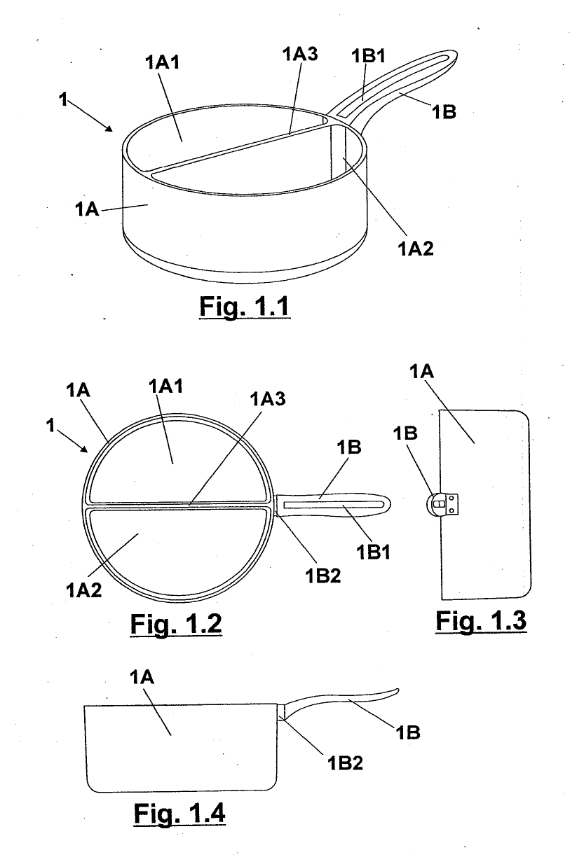

FIG. 01 is a perspective view of a cylindrical pan/pot with a single handle, a dividing wall and two compartments;

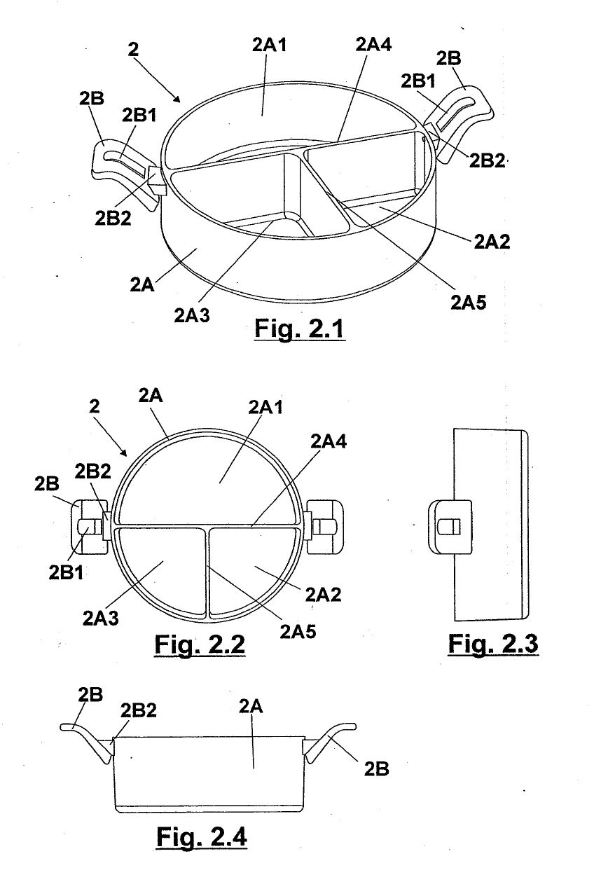

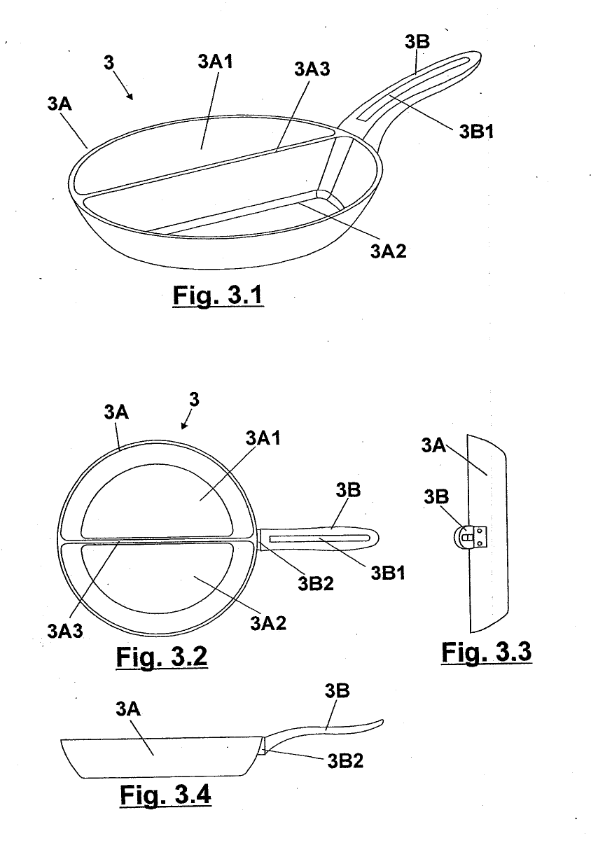

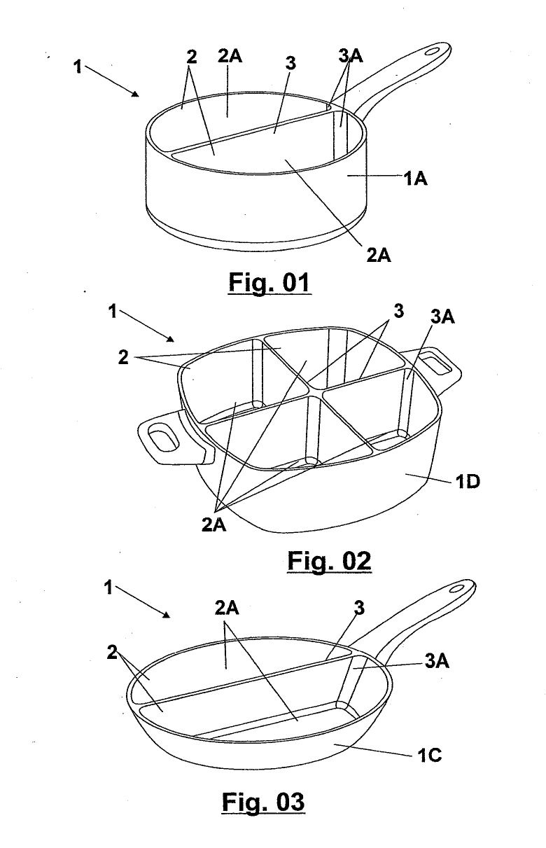

FIG. 02 is a perspective view of a square-shaped pot (with rounded corners) with two handles, two dividing walls and thus four internal compartments.

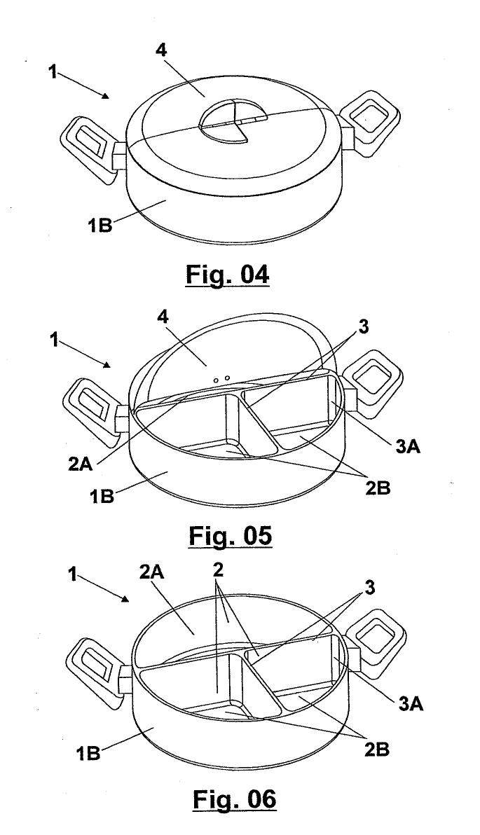

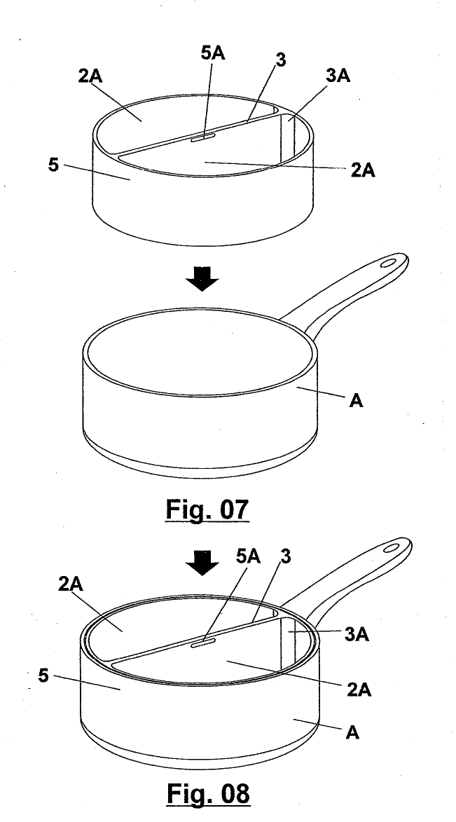

FIG. 03 is a perspective view of a frying pan with a single handle, a single dividing wall and two semi-circular compartments for frying food.

FIG. 04 is a perspective view of a cylindrical pan/pot with two opposed handles, two dividing walls (see FIG. 05) and three compartments, shown with the lid shown in a closed position.

FIG. 05 is a perspective view of a cylindrical pan/pot with two handles, two dividing walls and separators and three compartments, with the lid being shown in its partially open position to expose the two small compartments.

FIG. 06 is a perspective view of a cylindrical pot with two handles, two dividing walls or separators and three compartments. This is the same pot shown in FIGS. 04 and 05 with the lid 4 fully removed.

FIG. 07 is an exploded and perspective view of an insert or pot liner with an exterior cylindrical side wall, a centrally located dividing wall or separator (extending down the diameter of the insert or liner; for a pot A, shown with a single, outwardly projecting handle. The liner is, preferably, provided with a thin wall for its bottom, or the liner/insert has no bottom and sits flush upon the bottom of the pot.

FIG. 08 is a perspective view of the liner/insert shown in FIG. 07 as inserted within the confines of the pot (also shown in FIG. 07).

### DETAILED DESCRIPTION OF THE INVENTION AS SHOWN IN THE DRAWINGS AND THE PREFERRED EMBODIMENTS

As seen in the Figures, a set of cookware (pots and pans) is provided with internal dividers or separators. The cookware is preferably made from metal, likely metallic bottoms and more preferably the bottom is copper for even and quick heating. This cookware is generally used on stove tops (although, of course, the invention can find utility within stoves, too), whether they are powered by electric heating elements or gas (propane, for example). FIG. 1.1 shows a pot 1 comprising a cylindrical outer wall 1A, defining a pair of compartments 1A1 and 1A2, each of which is semi-cylindrical. The cylindrical body 1A is divided into the two compartments by a dividing wall or separator element 1A3 which extends from the inside, upper surface of the bottom of the pot or pan 1 vertically upwardly. Preferably, as seen in the drawings, the dividing wall or separator 1A3 extends to the top edge of the pot or pan. A handle 1B is provided to facilitate movement, placement and holding of the pot or pan 1. It is generally a curvilinear format and can be provided with a slot 1B1, centrally located along the longitudinal axis of the handle 1B. The provision of a slot or central opening 1B1 of the handle 1B decreases the weight of the pot or pan and makes the same easier to move and hold, especially since there is some increased weight as a consequence of the dividing wall 1A3 or separator. The base 1B2 of the handle 1B is preferably rectangular and connects, via conventional means, or can be slip on and slip off, to the outside side wall of the pot or pan 1. In the embodiment shown in FIGS. 1.2; 1.2; 1.3 and 1.4, the handle is shown screwed or welded to the outside side wall of the pot/pan 1.

According to the embodiment and configuration shown in general in FIG. 2.1, a pot 2 has a single outside or exterior cylindrical wall 2A. A separator 2A4 and 2A5, one bisecting the interior of the pot and the other perpendicular thereto divides the interior of the pot 2 into three compartments, a first large compartment 2A1 and a pair of substantially equal, quarter of the interior compartments, 2A3 and 2A2 sections. A pair of handles 2B are provided to opposed ends of the pan to facilitate movement of the pot, as desired. Here, too, the handles are provided with open slots 2B1 and a generally rectangular base 2B2 connecting the handle to the outside of the pot. The open slots 2B1 run down the longitudinal center of the handles to reduce the weight of the device. The handles are secured to the outsides of the pot 2 via securing sections 2B2. This pot could be used, for example, to cook three or more separate dishes, for example, in the large compartment could be either a double size portion of a stew, to be flavored with a first seasoning style; while compartments 2A3 and 2A2 could be used for either single portions of the same stew seasoned to a second and third individual taste or the smaller compartments could be used for different dishes, e.g., vegetables and a starch, e.g., broccoli and mashed potatoes.

The divider wall or separator 2A4 extends generally across the diameter of the interior of the cylindrical pot or pan and the divider wall or separator 2A5, forming, with the inside of the outer cylindrical wall of the pot, the two smaller compartments 2A2 and 23, extends along a radius of the inside cylindrical wall of the pot.

FIGS. 3.1; 3.2; 3.3 and 3.4 show a prying pan 3 containing a single outside and outwardly flared curved wall 3A. It, too, has a single and continuous bottom which allows for evenness of heating the entirety of the contents within the frying pan when placed upon a stove top. Two compartments 3A1 and 3A2 are defined by “down the center” dividing wall or separator 3A3, which extends from the bottom to the upper lip or top edge of the pan. A handle 3B is provided with a central slot or opening of semi-oblong or shape. The handle has a rectangular base 3B2 (see FIGS. 3.3 and 3.4. The handle is generally curvilinear so comfortable allow the user to grip the same so as to allow the pan to easily be placed on and removed from the stove top. The two compartments 3A1 and 3A2 divide the otherwise circular pan into two semi-cylindrical frying surfaces. This could be used to facilitate making two different dishes, e.g., fried or scrambled eggs in one compartment and bacon in the other or to make the same entree or dish but to the specific individual tastes of two individuals, e.g., scrambled eggs in both compartments with one being seasoned with peppers, tomatoes, and sausage, and scrambled eggs in the other compartment, seasoned only with salt.

As shown in FIG. 01 through 08, a divided pot/pan is provided for use in making individually seasoned portions of the same main course or food or, alternatively, for making two foods, e.g., an entree and one or more side dishes in the same pot/pan. The pot or pan is provided with a single flat surface which will rest upon the stove top and be heated by its heating element, whether accomplished by electric or gas. Thus, the pot/pan will provide an even and hot cooking surface to all compartments, at the same time, all controlled by the heating element of the cook or stove top. The present invention, however, allows for the economical use of a single heating element, a single pot/pan to make various individually seasoned meals or entrees at the same time and to make one or more entrees with one or more side dishes, also at the same time and by use of a common heating element. This, too, is economical in terms of use of pots/pans, in cleaning pots and pans after the meal, and in using the heating energy of the heating element for many food preparation steps at the same time. The present invention provides for the economical use of gas or electric, a reduction in the number of pots/pans needed for food preparation for a small family; and saves, too, in the clean up of dirty pots and pans. Also, by having a multi-compartment pot/pan, storage space is conserved. Also, special dietary restrictions and meals salted or seasoned to individual taste can be provided by use of the compartmentalized pot and pan, comprising, in general, a single integrated bottom cooking surface and a dividing wall which separates the interior cooking surface into two or more separate compartments.

The pots and pans of the present invention do not replace the traditional pots and pans that may be required for a full kitchen; however, the present invention assists in the preparation of food in a more compact and economical manner, when desired.

The present invention provides pots and pans with separate compartments for food preparation, each pot or pan having one or more dividing walls or separators. Preferably, the dividing walls are attached to the pot and pan by use of a concave corner element which divides the compartments in semi-circular or fractional round sections and rectangular sections, too (if the pot/pan is rectangular or square (even with rounded corners)). The concave-shaped corner elements, allowing the dividing wall to attach to the inside circumferential wall of the pan, allows for the cook, using standard cooking utensils to easily scrape the insider corners in order to ensure that no food sticks into the corners.

According to the preferred embodiments, the dividing walls or separators can effectively divide or split the pot or pan cooking surface into one, two, three, four or more cooking compartments. In an alternate embodiment, an insert or liner element can be selectively installed into a cooking pot or a pan, hollow on its bottom so that the cooking surface of the pot or pan is the cook surface for the compartments, or, optionally, the insert or liner can have a thin metallic bottom layer which ensures even heating to each compartment as the bottom layer of the insert or liner sits upon the bottom of the pot or pan. The present pots and pans and/or the insert or liner is not intended to replace the traditional pots and pans but are expected to be an aid in the preparation of food in a more economical manner.

The choice of the pot or pan needed for preparation of a meal is made at the beginning and the number of compartments determined to be equal to the number of food portions or individuals to be served or fed at the meal. Also, if the number of needed compartments is less than the number of available compartments of the divided pots and pans, then the cook can fill the extra compartment(s) with water. Then, as the meal is prepared in the needed compartments, the extra compartment(s) will heat the water and then, the dividing walls can be removed, as, for example, by removal of the insert/liner, and the water can be used in effectively cleaning the bottom of the compartments.

The Figures show a frying pan and/or pots and pans with dividing wall(s) or separators/partitions used to cook and fry foods on a stove top, whether powered by electric or gas heating. As shown in the Figures, the pots and pans are provided with one or more dividing walls having concave corners 3A which divide the compartments 2, into semicircular sections 2A or into fractional sections. The pots and pans can have bottoms and outside surfaces which are circular or cylindrical, and/or square or rectangular with rounded corners. FIGS. 01, 02, and 03 are pots and frying pans 1, with the variations of a circular pan 1A, a square pan 1D, and a frying pan 1C, showing the sections 2 made by the dividing walls to be semi-circular 2A and square-shaped 2C. The dividing walls 3 have concave or rounded corners to facilitate the scraping of food and eliminate/minimize the burning or overcooking of food trapped or held into the corners.

FIGS. 04, 05 and 06 show a version of the present invention with a round pan 1D with an opening lid which a) can be fully removed for exposing all compartments; can be flipped about a single large hinge to expose an entire ½ of the cooking area, i.e., a semi-circular section or, alternatively, can open about a smaller hinge to expose just one or the other ¼ of the cooking area, smaller sections. The concave corners are provided, again, to ensure that a cooking utensil will easily scrape material therefrom and minimize uneven cooking by food getting caught and maintained in the corners of the pot/pan.

FIGS. 07 and 08 shows a pot with an insert or liner element 5 with semicircular compartments 2A, dividing walls 3 and concave corners between the radial outward edges of the dividing walls and the inside circumferential edge or wall of the pot. The liner may have a thin-walled bottom which sits upon the base or bottom of the pot into which it is placed or, preferably, the liner/insert has no bottom and slides into the pot and the bottom of the pot is the direct cooking surface for the food. The liner can be removed and inserted as desired so that the pot can be used without the liner/insert or with the liner/insert, as desired and needed.

1. A pot or pan comprising one or more dividing walls for dividing the cooking surface into distinct cooking sections.

2. A pot or pan as claimed in claim 1 wherein said dividing wall is provided with concave extremities for securing the same to the inside of the pot or pan.

3. A pot or pan as claimed in claim 1 further comprising a cover.

4. A pot or pan as claimed in claim 3 wherein said cover is provided with one or more top hinges which allow for sections of said pot or pan to be exposed while keeping the balance of the pot or pan covered.

5. A pot or pan as claimed in claim 1 wherein said distinct cooking sections are semi-circular.

6. A pot or pan as claimed in claim 1 wherein said distinct cooking sections are rectangular.

7. A pot or pan as claimed in claim 1 further comprising one or more handles.

8. A pot or pan as claimed in claim 7 wherein said handles are provided with slot like openings.

9. An insert for a pot or pan comprising one or more dividing walls which divide the cooking surface of the pot or pan into distinct cooking sections, said insert corresponding in shape and dimensions to the inside wall of the pot or pan.

10. An insert as claimed in claim 9 wherein said dividing walls are provided, at their juncture with the inside surface of the pot or pan with a concave surface extending from the bottom cooking surface to about the top lip of the pot or pan.

11. An insert as claimed in claim 9 wherein said divider walls sit directly upon the bottom surface of a pot or pan into which the same is placed.

12. An insert as claimed in claim 9 having a thin-walled bottom cooking surface.

13. An insert as claimed in claim 9 wherein a slot is provided extending through at least one of said dividing walls for use in connection with placement and removal of said insert into and out of said pot or pan.

14. A pot or pan as claimed in claim 1 wherein said bottom edges of said dividing walls are provided with inwardly directed scraping surfaces which allow for a cooking implement to be scraped thereagainst for ensuring even heating and cooking of food contained within the compartments.
